(19) United States
(12) Patent Application Publication
(10) Pub. No.: US 2006/0143320 A1
(43) Pub. Date: Jun. 29, 2006

(54) SYSTEM AND METHOD FOR CHECKING DRIVERS OF HARDWARE DEVICES OF A COMPUTER

(76) Inventors: Jian-Jun Zhu, Shenzhen (CN); Ping-Hui Chen, Shenzhen (CN)

Correspondence Address: NORTH AMERICA INTELLECTUAL PROPERTY CORPORATION, P.O. BOX 506, MERRIFIELD, VA, 22116, US

(21) Appl. No.: 11/163,900

(22) Filed: Nov. 3, 2005

(30) Foreign Application Priority Data
Dec. 28, 2004 (TW) 093140947

(51) Int. Cl. G06F 3/00

(52) U.S. Cl. 710/8

(57) ABSTRACT

The present invention provides a system for checking drivers of hardware devices of a computer (10). The system includes: a traveling module (101) for traveling a tree structure of the drivers by accessing the System Regedit of the computer through an application programming interface; a retrieving module (102) for retrieving an error code for each of the drivers and contents of an initialization file which includes information on a version of each of the drivers; and a determining module (103) for determining whether a driver is installed properly according to the corresponding error code, and for determining whether the driver has a correct version according to the contents of the initialization file. A related method is also provided.

### FIELD OF THE INVENTION

The present invention is generally related to systems and methods for checking a computer, and more particularly, to a system and method for checking drivers of computer hardware devices.

### DESCRIPTION OF RELATED ART

A computer typically have various kinds of hardware devices installed therein, such as a center processing unit (CPU), a memory, a hard disk, a monitor, a mouse and a keyboard. The computer may further have various kinds of software installed therein, such as an operating system (OS), application software, and drivers for corresponding hardware devices. The OS communicates with and manages a hardware device through a corresponding driver. Drivers are available from corresponding hardware devices manufacturers, and are usually provided to users accompanying corresponding hardware devices bought by the users.

When a new hardware device is installed in the computer, a corresponding driver needs be installed subsequently, so that the OS can find the new hardware device and manage it through the driver. If the driver is installed improperly or has an incorrect version, the OS can not communicate with the hardware device normally, and the worst, the hardware device can not work normally under the OS. Accordingly, there is a need to check a driver for a corresponding hardware device once installed in a computer.

A China patent application publication No. 1504887 entitled “Apparatus and method for checking a universal serial bus (USB) port of a computer” is published on Jun. 16, 2004. The patent application discloses a method for checking a USB port and a corresponding driver of a computer. However, the patent application can only check the driver for the corresponding USB port of the computer.

Accordingly, what is needed is a solution that can check all drivers of hardware devices of a computer.

### SUMMARY OF INVENTION

One embodiment of the present invention provides a system for checking drivers of hardware devices of a computer. The system includes: a traveling module for traveling a tree structure of the drivers by accessing the System Regedit of the computer through an application programming interface; a retrieving module for retrieving an error code for each of the drivers and contents of an initialization file which includes information on a version of each of the drivers; and a determining module for determining whether a driver is installed properly according to the corresponding error code, and for determining whether the driver has a correct version according to the contents of the initialization file.

One embodiment of the present invention provides a method for checking drivers of hardware devices of a computer. The method includes the steps of: traveling a tree structure of the drivers by accessing the System Regedit of the computer through an application programming interface; retrieving an error code for each of the drivers and contents of an initialization file which includes information on a version of each of the drivers; and determining whether a driver is installed properly according to the corresponding error code, and whether the driver has a correct version according to the contents of the initialization file.

Other systems, methods, features, and advantages of the present invention will be or become apparent to one with skill in the art upon examination of the following drawings and detailed description.

### BRIEF DESCRIPTION OF DRAWINGS

FIG. 1 is a schematic diagram illustrating a hardware environment of implementing a system for checking drivers of hardware devices of a computer, in accordance with one embodiment of the present invention;

FIG. 2 is a schematic diagram illustrating function modules of the computer of FIG. 1;

FIG. 3 is a flowchart illustrating a method for checking drivers of hardware devices of a computer, in accordance with one embodiment of the present invention; and

FIG. 4 is a flowchart illustrating one step of FIG. 3 in detail, namely checking the drivers.

### DETAILED DESCRIPTION

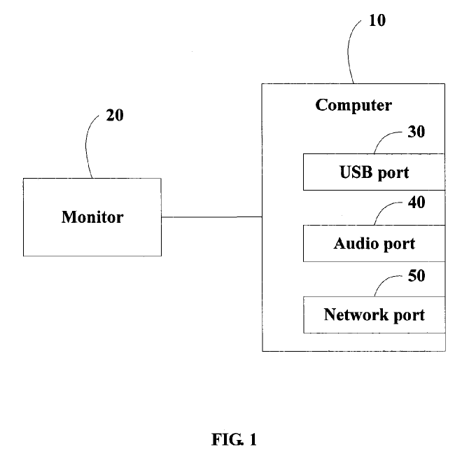

FIG. 1 is a schematic diagram illustrating a hardware environment of implementing a system for checking drivers of hardware devices of a computer, in accordance with one embodiment of the present invention. In FIG. 1, a computer 10 is connected with a monitor 20. The monitor 20 provides a user with a graphic user interface (GUI), in order that the user can interact with the computer 10.

The computer 10 has various kinds of ports for connecting with corresponding hardware devices. A universal serial bus (USB) port 30 can be used to connect a USB hardware device, such as a USB flash memory or a USB mouse. An audio port 40 can be used to connect an audio adapter. A network port 50 can be used to connect a network adapter. The computer 10 can further have other kinds of ports for connecting other hardware devices. Each hardware device connected to the computer 10 has a corresponding driver installed properly in the computer 10, through which an operating system (OS) installed in the computer can communicate and manage the hardware device.

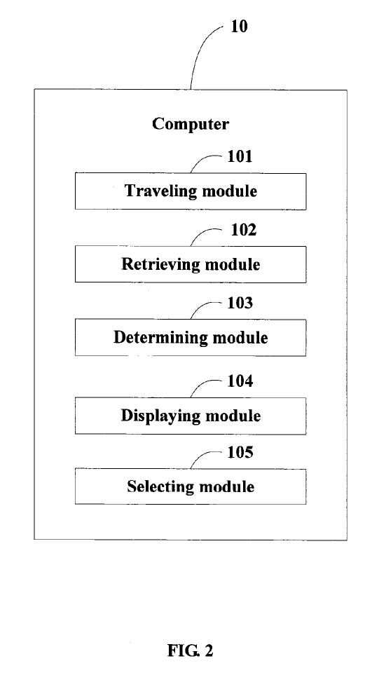

FIG. 2 is a schematic diagram illustrating function modules of the computer 10 of FIG. 1. The computer 10 can be used to check a plurality of drivers of hardware devices installed therein. The computer 10 includes a traveling module 101, a retrieving module 102, a determining module 103 a displaying module 104 and a selecting module 105.

The traveling module 101 is used for traveling a tree structure of the plurality of drivers by accessing the System Regedit of the computer 10 through an application programming interface (API). The retrieving module 102 is used for retrieving an error code for each of the drivers, and for retrieving contents of a corresponding initialization file which includes information on a version of the driver. The determining module 103 is used for determining whether the driver is installed properly according to the error code, and for determining whether the version of the driver is correct according to the contents of the initialization file.

The displaying module 104 is used for displaying results generated by the determining module 103 on the monitor 20. The selecting module 105 is used for providing a plurality of functions on the monitor 20 for the user to select. The plurality of functions include: displaying information of each of the drivers, opening the Hardware Device Manager of the computer, displaying the drivers which are installed improperly or the drivers whose versions are incorrect, and saving all the drivers into a designated file.

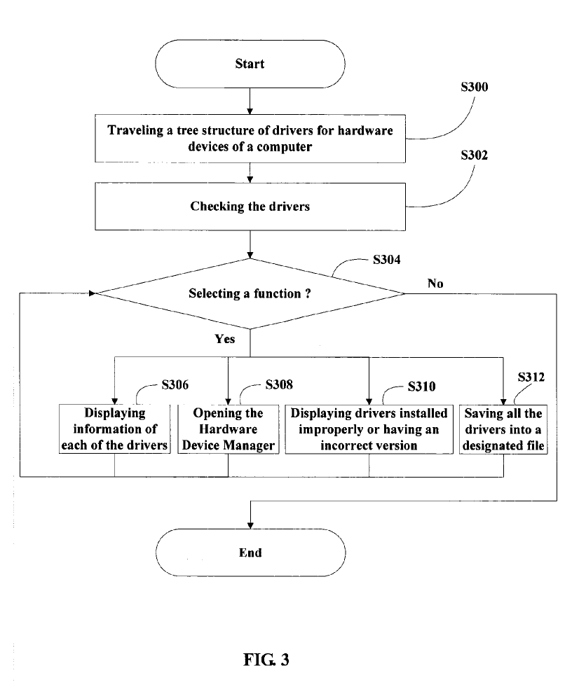

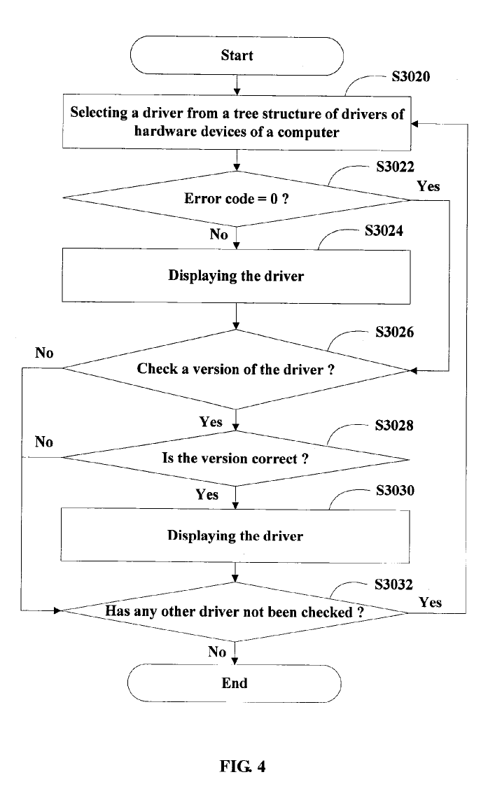

FIG. 3 is a flowchart illustrating a method for checking drivers of hardware devices of the computer 10, in accordance with one embodiment of the present invention. In step S300, the traveling module 101 travels a tree structure of the drivers by accessing the System Regedit of the computer 10 through an API. In step S302, the retrieving module 102 and the determining module 103 check the drivers collectively. Detailed description of the step S302 is provided below in relation to FIG. 4.

In step S304, the selecting module 105 provides a plurality of functions on the monitor 20 for a user to select. The plurality of functions include: displaying information of each of the drivers (step S306), opening the Hardware Device Manager of the computer 10 (step S308), displaying the drivers which are installed improperly or the drivers whose versions are incorrect (step S310), and saving all the drivers into a designated file (step S312). The user can select one or more functions from the plurality of functions described above, and can also select to quit.

FIG. 4 is a flowchart illustrating step S302 of FIG. 3 in detail. In step S3020, the retrieving module 102 selects a driver from the tree structure of the drivers of hardware devices installed in the computer 10. In step S3022, the retrieving module 102 retrieves an error code for the selected driver, and the determining module 103 determines whether the selected driver is installed properly according to the retrieved error code. If the error code is zero, the selected driver is regarded as being installed properly, then the procedure goes directly to step S3026 described below. Otherwise, if the error code is not zero, the selected driver is installed improperly, then in step S3024, the displaying module 104 displays information on the driver including information on a version of the driver.

In step S3026, the determining module 103 determines whether it is necessary to check the version of the driver according to checking demands. If there is no need to check the version, the procedure goes directly to step S3032 described below. Otherwise, if there is a need to check the version of the driver, in step S3028, the retrieving module 103 retrieves contents of a corresponding initialization file which includes information on a version of the selected driver, and the determining module 103 determines whether the version of the driver is correct according to the contents of the initialization file.

If the version is not correct, the procedure goes directly to step S3032 described below. Otherwise, if the version is correct, in step S3030, the displaying module 104 displays the driver and the version.

In step S3032, the determining module 103 determines if any other driver in the tree structure has not been checked. If any driver in the tree structure has not been checked, the procedure returns to step S3020 described above. Otherwise, if all the drivers in the tree structure have been checked, the procedure ends.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

What is claimed is:

1. A system for checking drivers of hardware devices of a computer, the system comprising:
a traveling module for traveling a tree structure of the drivers by accessing the System Regedit of the computer through an application programming interface;
a retrieving module for retrieving an error code for each of the drivers and contents of an initialization file which includes information on a version of each of the drivers; and
a determining module for determining whether a driver is installed properly according to the corresponding error code, and for determining whether the driver has a correct version according to the contents of the initialization file.

2. The system according to claim 1, further comprising a displaying module for providing a graphic user interface for displaying results generated by the determining module on a monitor.

3. The system according to claim 1, further comprising a selecting module for providing a plurality of functions for a user to select, the plurality of functions comprising:
displaying information of each of the drivers;
opening the Hardware Device Manager of the computer;
displaying the drivers which are installed improperly or the drivers whose versions are incorrect; and
saving all the drivers into a designated file.

4. A method for checking drivers of hardware devices of a computer, the method comprising the steps of:
traveling a tree structure of the drivers by accessing the System Regedit of the computer through an application programming interface;
retrieving an error code for each of the drivers and contents of an initialization file which includes information on a version of each of the drivers; and
determining whether a driver is installed properly according to the corresponding error code, and whether the driver has a correct version according to the contents of the initialization file.

5. The method according to claim 4, further comprising the step of displaying results generated by the determining step.

6. The method according to claim 4, further comprising the step of selecting a function from a group of functions of:
displaying information of each of the drivers;
opening the Hardware Device Manager of the computer;
displaying the drivers which are installed improperly or the drivers whose versions are incorrect; and
saving all the drivers into a designated file.
